(19) United States
(12) Patent Application Publication
(10) Pub. No.: US 2025/0340774 A1
(43) Pub. Date: Nov. 6, 2025

(54) CONCRETE FORMULATION FOR SEALING AND PLUGGING OIL OR GAS WELLS FOR ABANDONMENT

(71) Applicant: University of Kentucky Research Foundation, Lexington, KY (US)

(72) Inventors: Thomas Robl, Lexington, KY (US); Robert B. Jewell, Lexington, KY (US); Anne Oberlink, Lexington, KY (US); Tristana Duvallet, Lexington, KY (US)

(21) Appl. No.: 19/265,798

(22) Filed: Jul. 10, 2025

Related U.S. Application Data
(63) Continuation of application No. 18/147,838, filed on Dec. 29, 2022, now abandoned.
Application No. 18/147,838 is a continuation-in-part of application No. 16/657,543, filed on Oct. 18, 2019, now Pat. No. 11,560,334.
(60) Provisional application No. 62/749,384, filed on Oct. 23, 2018.

(51) Int. Cl. C09K 8/42; C04B 2/02; C04B 7/02; C04B 7/32; C04B 103/60

(52) U.S. Cl. CPC C09K 8/426; C04B 2/02; C04B 7/02; C04B 7/323; C04B 2103/603

(57) ABSTRACT

An improved oil or gas well cement for penetrating, sealing and plugging wells to be abandoned. The cement fill includes (a) a cement component including a calcium sulfoaluminate cement and a Portland cement having a ratio by weight of Portland cement to calcium sulfoaluminate cement ranging from 1/19 to 1/5 and (b) an aggregate component with gradation spanning 1,200 microns to 5 microns. Further an improved oil or gas well microcellular cement for penetrating sealing and completely filling wells to be abandoned that includes (a) a cement component including a calcium sulfoaluminate cement and a Portland cement having a ratio by weight of Portland cement to calcium sulfoaluminate cement ranging from 1/19 to 1/5 and (b) an aggregate component with gradation spanning 200 microns to 5 microns and (c) a foaming agent.

### RELATED APPLICATION

This application is a continuation of U.S. Utility patent application Ser. No. 18/147,838, filed Dec. 29, 2022, which is a continuation-in-part (CIP) of U.S. Utility patent application Ser. No. 16/657,543 filed on Oct. 18, 2019, which claims priority to U.S. Provisional Patent Application 62/749,384 filed on Oct. 23, 2018, all of which are hereby incorporated by reference in their entirety.

### TECHNICAL FIELD

This document relates generally to a new and improved cement fill or concrete formulation adapted to plug and seal an oil or gas well or well casing for safe abandonment purposes.

### BACKGROUND

The new and improved cement fill or concrete formulation is adapted to better plug and seal an oil or gas well for closure and abandonment. The cement fill or concrete formulation has a number of physical attributes that make it ideal for this application. The cement fill or concrete formulation can be formulated to have a very low viscosity during application to make certain it flows, fills, and penetrates well casings where present, or covers and seals effectively rock strata where not present. The cement fill or concrete formulation exhibits a very high bond strength and will effectively bond to a variety of materials such as dirty concrete and asphaltic surfaces, steel or rocks. These kinds of surfaces are commonly associated with oil and gas wells. It is also shrink resistant over time thereby better ensuring that the seal between the cement fill/concrete formulation and well rock surface, where the casing of the well has been removed; or the casing itself, where removal is not practical or possible.

Depending upon the state regulations (e.g., 805 KAR 1:060. Plugging Wells) the production zone or zones must be plugged, or a bridge is set above them, and a cement plug pumped in via tubing or a bailer. In Kentucky, this plug must be at least 15 feet in depth. Additionally, a plug of cement of 15 feet must be set below any aquifer. However, many old wells have no, or sparse records having been drilled before regulations were passed and production zones are multiple or unknown and uncertain. For these cases the cement plug strategy is not assured, and the entire depth of the well should be filled and sealed.

For this the cement formulation is treated with foaming agents to create a very rapid setting microcellular foamed concrete. The nature of the cement is critical in stabilizing the foam in this application, as the set time can be shortened to as little as 2 minutes. This approach is not feasible with conventional Portland cement-based oil and gas well cements, where the pressure from the depth in these wells breakdown the bubbles and collapses the foam. The microcellular concrete application provides the ability to penetrate casings and strata and fill and seal the entire depth of the well quickly and at reasonable cost.

### SUMMARY

In accordance with the purposes and benefits described herein, an oil or gas well, prepared for abandonment, consisting essentially of a well that may be open to the surrounding rock, or a well casing that is cemented to the formation rock around the well casing. The cement fill includes (a) a cement component including a calcium sulfoaluminate cement and a Portland cement having a ratio by weight of Portland cement to calcium sulfoaluminate cement ranging from 1/19 to 1/5 and (b) an aggregate component with gradation spanning 1,200 microns to <5 microns.

In one or more of the many possible embodiments, the cement fill further includes an additive selected from a group consisting of a foaming agent, a water reducing agent, a set time retarder, and combinations thereof. The foaming agent may comprise an organic foaming agent, an inorganic foaming agent or combinations of the two. Foaming agents, water reducing agents and set time retarders useful for this application are generally known in the art.

In one or more of the many possible embodiments, the aggregate component includes a coarse fraction of limestone, dolomitic limestone, dolomite or quartz sand ranging in size from minus 1,200 microns to ˜62.5 microns, and a finer fraction of milled limestone, quartz flour or fly ash constituting at least 10% of the final product.

In another of the many possible embodiments, the aggregate component includes only finer fractions of limestone, dolomitic limestone, dolomite, fly ash or quartz that are less than 250 microns in size.

In an additional aspect, an oil or gas well, comprises, consists essentially of, or consists of a well with or without a casing and a concrete formulation adapted to engage and plug the well casing or the exposed well bore if the well casing or a portion thereof has been removed. The concrete formulation including (a) a cement component including a calcium sulfoaluminate cement and a Portland cement having a ratio by weight of Portland cement to calcium sulfoaluminate cement ranging from 1/19 to 1/5, and (b) an aggregate component with gradation spanning 1,200 microns to <5 microns.

In one or more of the many possible embodiments, the concrete formulation further includes an additive selected from a group consisting of a foaming agent, a water reducing agent, a set time retarder, and combinations thereof. As noted above, the foaming agent may comprise an organic foaming agent, an inorganic foaming agent or combinations of the two. Foaming agents, water reducing agents and set time retarders useful for this application are known in the art.

In accordance with an additional aspect, a new and improved concrete formulation for oil and gas well plugging and abandonment applications comprise, consists essentially of or consists of: (a) cement component including a calcium sulfoaluminate cement and a Portland cement having a ratio by weight of Portland cement to calcium sulfoaluminate cement ranging from 1/19 to 1/5, and (b) an aggregate component with gradation spanning 1,200 microns to <5 microns.

In one or more of the many possible embodiments, the concrete formulation further includes a water reducing agent, a set time retarder, a foaming agent, and combinations thereof. The set time retarder, if used, may be provided at a first dosage range from 0.02% to 0.40% by weight of the concrete formulation. The water reducing agent may be provided at a second dosage range of 0.75-1.25% by weight of the concrete formulation.

In the following description, there are shown and described several embodiments of the concrete formulation and the oil and gas well. As it should be realized, the concrete formulation and the oil and gas well are capable of other, different embodiments and their several details are capable of modification in various, obvious aspects all without departing from the concrete formulation and the oil and gas well as set forth and described in the following claims. Accordingly, the drawings and descriptions should be regarded as illustrative in nature and not as restrictive.

### BRIEF DESCRIPTION OF THE DRAWING FIGURES

FIG. 1 illustrates the infrastructure of an oil or gas well.

FIG. 2 is a detailed illustration of one possible embodiment of an oil or gas well sealing plug.

FIG. 3 is an example of a well filled in part with the improved plugging material and microcellular foamed concrete.

Reference will now be made in detail to the present preferred embodiments of the oil or gas well, examples of which are illustrated in the accompanying drawing figures.

### DETAILED DESCRIPTION

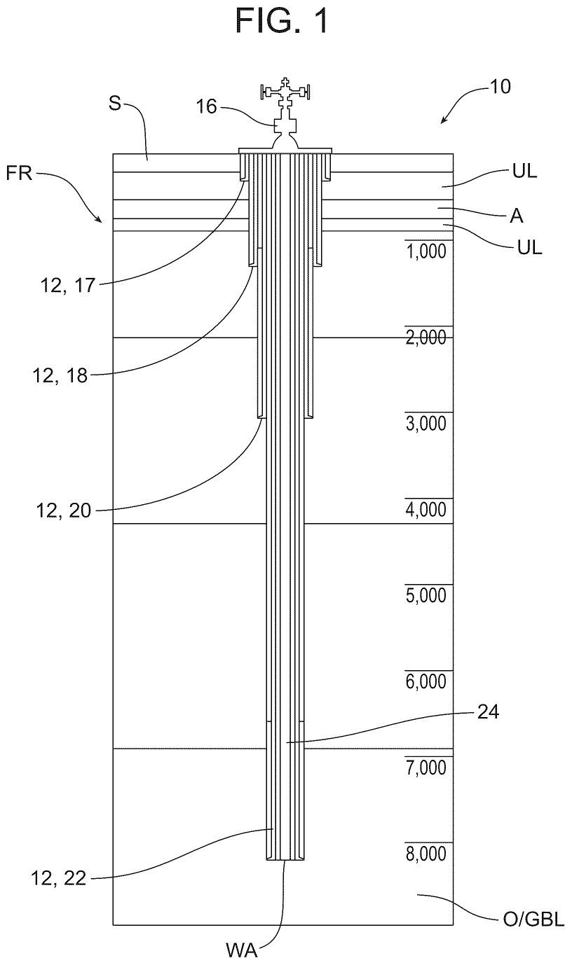

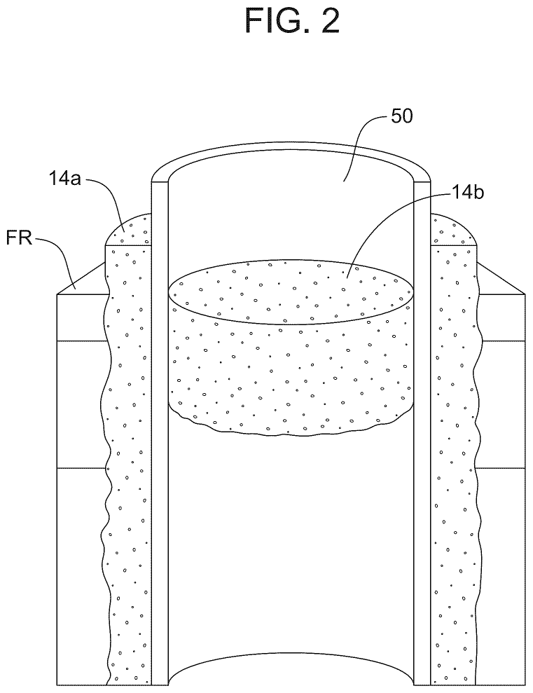

As illustrated in FIGS. 1 and 2, an oil or gas well 10 includes a well casing 12 and a Portland cement fill or concrete formulation 14 particularly adapted for oil well applications.

Turning now to FIG. 1, the oil or gas well 10 includes a well head 16 at the top of a well casing 12. The well casing 12 includes: (a) a conductor casing 17, (b) a surface casing 18 that extends downward from the conductor casing through the soil S and the upper layer UL of the earth past the aquifer A, (c) an intermediate casing 20 that extends downward into the formation rock FR from the surface casing and (d) a production casing 22 extending to the bottom of the oil or gas well 10. The well casing 12 extends concentrically around a well annulus WA that is drilled in the formation rock FR and through which oil and gas are recovered from the oil and/or gas bearing layer O/GBL. Certain wells may be simpler in configuration lacking a intermediate casing for example.

When plugging an oil or gas well 10 of the type illustrated in FIG. 1, one first checks the hole pressures of the well. If the well has pressure, the pressure will need to be relieved and weighted fluids above the bottom hole pressure will need to be circulated in the well 10.

If no pressure is found, the well head 16 is removed. Next, the downhole pump and rods (not shown) are removed if the well 10 incorporated such an artificial lift system. This is followed by the removal of the production tubing 24.

Depending on the condition of the well casing or casings and their salvage potential, two conditions will now remain. One where the casings are salvageable and recovered and a second where the casing or casings are not salvageable or cannot be removed and must be treated in situ. Depending upon the state regulations, the production zone or zones are plugged, or a bridge is set above them, and a cement plug is pumped in via tubing or a bailer. In Kentucky (805 KAR 1:060. Plugging Wells), this plug must be at least 15 feet in thickness. Additionally, a plug of cement of 15 feet in thickness must be set below any aquifer.

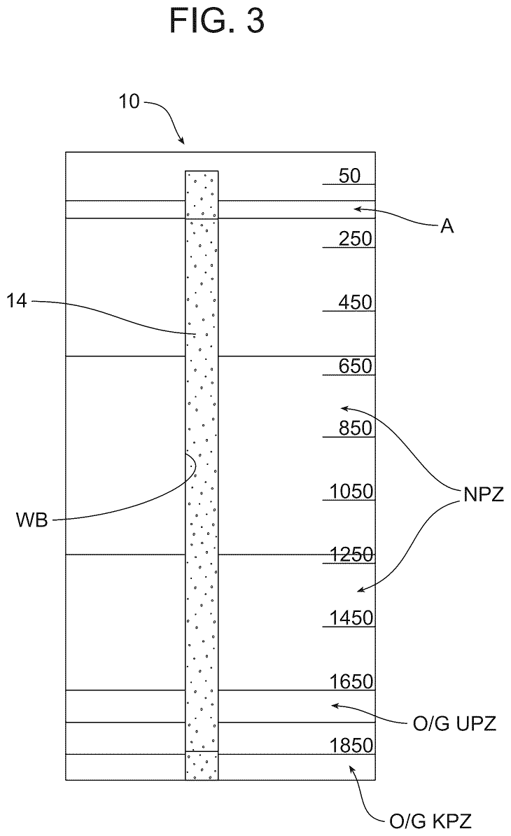

Turning now to FIG. 3, an example of an old shallow abandoned well with little or no documentation and with or without recoverable casings, typical of many wells in Appalachia. Here a second approach is illustrated. The entire exposed well bore WB is filled with a combination of foamed and non-foamed concrete formulation 14. The well is plugged through the known oil or gas production zone (O/G KPZ) and an aquifer (A) with the improved formula describe, and the remainder filled with the foamed microcellular concrete or cement as describe. Note that an unknown oil or gas production zone (O/G UPZ) is also sealed in this approach that would have been missed in the plugging method commonly employed.

A final plug of cement fill/concrete formulation (not shown) is placed at the water contact point in the well: that is at the point of contact with the aquifer A in FIGS. 1 and 3. In some cases this zone is plugged below the aquifer, in others through the aquifer depending on state regulations. The soil S around the conductor casing 17 is then removed and all exposed pipe is cut and removed. A plugging cap (not shown), of a type known in the art, is then welded on top of all exposed pipe. The exposed pipe is then covered in fresh soil and the well is tented and monitored for leaks.

For this invention, the cement fill/concrete formulation includes a cement component and an aggregate component. The cement component includes a calcium sulfoaluminate (CSA) cement and a Portland cement, more particularly ordinary Portland cement (OPC). The cement component has a ratio by weight of Portland cement to calcium sulfoaluminate cement ranging from 1/19 to 1/5. The aggregate component has a gradation spanning 1,200 microns to <5 microns.

The cement fill/concrete formulation may further include one or more of the following: a foaming agent, a water reducing agent and a set time retarder. The foaming agent may comprise an organic foaming agent, an inorganic foaming agent or combinations of the two. Typically, organic foaming agents are protein based. Any foaming agent known in the art to be useful in cement/concrete applications may be used. Such foaming agents include, but are not necessarily limited to ProPump 26, Propump 40 (both organics) and Propump Synthetic foaming agents available from Propump Engineering, LTD. of Crayford, Kent, United Kingdom. The foam may be formed and blended with the cement or formed in situ in the delivery tubbing. The foaming agent may be provided at a dosage range that is required to meet the final targeted density of the microcellular concrete formulation ranging from 600 kg/m³-1500 kg/m³ (37 to 93 lbs./ft³).

The set time retarder, if used, may be selected from a group of set time retarding agents consisting of citric acid, tartaric acid, glucose, and mixtures thereof. In other embodiments of the cement fill or concrete formulation, other set time retarding agents known in the art may be used. If used, the set time retarder may be provided at a dosage range of 0.02%-0.40% by weight of the total concrete formulation.

The water reducing agent may be selected from a group of water reducing agents consisting of naphthalene sulfonates, polycarboxylates, or melamine-based agents and combinations thereof. In other embodiments of the cement fill or concrete formulation, other water reducing agents known in the art may be used. The water reducing agent, if needed, is provided at a dosage range of 0.75-1.25% by weight of the total concrete formulation.

The aggregate component may include both coarse aggregates, of limestone, dolomitic limestone, dolomite, or quartz sand, between ˜62.5 and 1,200 microns in diameter and fine aggregate of limestone, dolomitic limestone, fly ash or quartz between less than 5 microns to 62.5 microns in diameter.

The fine aggregates include limestone, dolomitic limestone, fly ash and quartz sand of less than 62.5 microns. Thus, the aggregate component has gradation spanning 1,200 microns to less than 5 microns. In at least one useful embodiment, the aggregate component includes a quartz flour filler with an average particle size of 5 microns and or a ultrafine limestone with an average particle sizes of 3 microns. In some embodiments, the aggregate component has gradation spanning 200 microns to 5 microns.

FIG. 2 is a detailed schematic illustration of a sealed well casing 50 within formation rock FR. Note the cement fill 14a, typically of oil field Portland cement such as Type H, extending completely around the well casing 50 between the well casing and the formation rock FR as well as the concrete formulation 14b of this invention extending completely across the interior of the well casing and plugging and sealing it.

### Experimental Section

Coarse Aggregates (i.e. +62.5 microns). Multiple sizes or fractions of limestone (or dolomitic limestone, dolomite, or quartz sand) aggregates ranging up to 1,200 microns in diameter down to 62.5 microns in diameter are used.

Fine Aggregates (i.e., less than 62.5 microns). The fine sized aggregates include milled limestone, such as AC-3 a 3 micron sized product produced by Mississippi Lime, Class F fly ash and quartz flour such as Min-U-Sil 5, a 5-micron material produced by U.S. Silica. This component gives the product both density, and in low viscosity formulations, improved penetration into and through well casings. Additionally these improve the density and strength of microcellular foamed concrete.

Cement. The primary cement is a calcium sulfoaluminate (CSA) as supplied by Buzzi Unicem USA. CSA cement gives the product its superior bonding ability. CSA cement constitutes between 20% and 25% by weight of the total product, preferably 22.2%. For the microcellular foam concrete the relative amount of cement may be increased. Ordinary Portland cement (OPC) is added to improve carbonation resistance and increase alkalinity, this constitutes from 1/19 (˜5%) to 1/5 (20%) of the total weight of the cement binder.

Additive Package, Water Reducers. Additives include the use of Conpac 500, a dry high range water reducer produced by the Kerneos Corporation in a dosage from 0.75% to 1.25% percent by weight of cement, preferably 1%. The dosage allows the product to have low viscosity needed to fill and seal the casing or rock strata yet still maintain a sufficiently low water cement ratio. Other water reducers available in a powder form, including naphthalene sulfonates and melamine-based agents, may also be used in equivalent dosage. The preferred water content (W) is, as a ratio to total weight of cement content (CSA+OPC, C), or W/C, of between 45% and 55% but not to exceed 75%.

Additive Package: Dry Set Time Modifiers. The product also contains a set time retarder, citric acid, in a dosage range of 0.02% to 0.40% weight, added in enough quantity to achieve a range of delayed set times needed for mixing and pumping. Other suitable set time retarders include tartaric acid and glucose in equivalent dosage. A mixture of dry set time modifiers may also be applied.

Additive Package: Liquid Set Time Modifiers. In another version of this cement filler/concrete formulation, a liquid set time modifier supplied in an additional package may be used, such as that supplied by the RussTech Corporation, comprised of Glucose (10-20%), 2-Hydroxy-1,2,3Propanetricarboxylic Acid (10-20%) Gluconic Acid (10-20%), Tartaric Acid (10-20%), and Polyhydric Alcohol (10-20%). The dosage range for this product is 6 to 16 oz/100pounds (3.9 to 10.4 ml/kg) of cement, enough to produce 60 minutes of set time reduction.

As noted above, the concrete formulation has a number of physical characteristics that make it ideal for oil and gas well applications. It has low viscosity which allows it to both penetrate and coat the oil casing and the rock formation. It has high bonding strength to ensure a good seal following penetration and fill. Additionally, it is shrink resistant and will not contract over time. In contrast, oil and gas well concrete formulations known in the art do shrink over time, releasing their bond to the well casing and thereby causing a micro annulus around the casing or rock strata that allows gas to pass by the plug. This problem is effectively avoided when using the new concrete formulation.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a foaming agent”, as used herein, may also refer to, and encompass, a plurality of foaming agents.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to +10% of the stated numerical value.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A concrete formulation, comprising:
a cement component including a calcium sulfoaluminate cement and a Portland cement; and
an aggregate component including coarse aggregates between 62.5 microns and 1,200 microns in diameter and fine aggregates between 62.5 microns to less than 5 microns in diameter.

2. The concrete formulation of claim 1, further including a foaming agent.

3. The concrete formulation of claim 2, wherein the foaming agent is sufficient to create a microcellular foamed concrete with densities ranging from 600 kg/m³-1500 kg/m³.

4. The concrete formulation of claim 3, wherein the foaming agent is selected from a group consisting of an organic foaming agent, an inorganic foaming agent and combinations thereof.

5. The concrete formulation of claim 1, wherein the foaming agent is selected from a group consisting of an organic foaming agent, an inorganic foaming agent and combinations thereof.

6. The concrete formulation of claim 2, wherein the aggregate component includes screen fractions of aggregates that are less than 250 microns in diameter consisting of multiple sizes or fractions of limestone (or dolomitic limestone, dolomite, or quartz sand) aggregates ranging up to no more than 200 microns in diameter and fine aggregates that include milled limestone, Class F fly ash, and/or quartz flour wherein a relative proportion of fine aggregate and cement increases proportionately with a targeted decrease in concrete density.

7. The concrete formulation of claim 3, wherein the aggregate component includes screen fractions of aggregates that are less than 250 microns in diameter consisting of multiple sizes or fractions of limestone (or dolomitic limestone, dolomite, or quartz sand) aggregates ranging up to no more than 200 microns in diameter and fine aggregates that include milled limestone, Class F fly ash, and/or quartz flour wherein a relative proportion of fine aggregate and cement increases proportionately with a targeted decrease in concrete density.

8. The concrete formulation of claim 2, wherein the concrete formulation further includes (a) a water reducing agent, (b) a set time retarder or (c) a set time retarder and a water reducing agent.

9. The concrete formulation of claim 3, wherein the concrete formulation further includes (a) a water reducing agent, (b) a set time retarder or (c) a set time retarder and a water reducing agent.

10. The concrete formulation of claim 1, wherein (a) the cement component has a ratio by weight of Portland cement to calcium sulfoaluminate cement ranging from 1/19 to 1/5, (b) the aggregate component has gradation spanning 1,200 microns to less than 5 microns and (c) the concrete formulation forms a fill plug within or above a production zone of a well bore of an oil or gas well below any aquifers.

11. The concrete formulation of claim 10, wherein the concrete formulation further includes (a) a water reducing agent, (b) a set time retarder or (c) a set time retarder and a water reducing agent.

12. The concrete formulation of claim 11, wherein the aggregate component includes screen fractions of coarse aggregates (i.e. +62.5 microns) consisting of multiple sizes or fractions of limestone (or dolomitic limestone, dolomite, or quartz sand) aggregates ranging up to 1,200 microns in diameter down to 62.5 microns in diameter and fine aggregates, of less than 62.5 microns, that include milled limestone, Class F fly ash, and/or quartz flour.

13. The concrete formulation of claim 1, wherein (a) the cement component has a ratio by weight of Portland cement to calcium sulfoaluminate cement ranging from 1/19 to 1/5, (b) the aggregate component has gradation spanning 1,200 microns to less than 5 microns and (c) the concrete formulation forms a plug in a well casing of an oil or gas well.

14. The concrete formulation of claim 13, wherein the concrete formulation further includes (a) a water reducing agent, (b) a set time retarder or (c) a set time retarder and a water reducing agent.

15. The concrete formulation of claim 14, wherein the aggregate component includes screen fractions of coarse aggregates (i.e. +62.5 microns) consisting of multiple sizes or fractions of limestone (or dolomitic limestone, dolomite, or quartz sand) aggregates ranging up to 1,200 microns in diameter down to 62.5 microns in diameter and fine aggregates, of less than 62.5 microns, that include milled limestone, Class F fly ash, and/or quartz flour.

16. The concrete formulation of claim 1, wherein (a) the cement component has a ratio by weight of Portland cement to calcium sulfoaluminate cement ranging from 1/19 to 1/5, (b) the aggregate component has gradation spanning 1,200 microns to less than 5 microns, (c) the concrete formulation further includes a foaming agent and (d) the concrete formulation fills an entire length of an exposed well bore of an oil and gas well where at least a portion of a well casing has been removed.

17. The concrete formulation of claim 16, wherein the foaming agent is sufficient to create a microcellular foamed concrete with densities ranging from 600 kg/m³-1500 kg/m³.

18. The concrete formulation of claim 17, wherein the concrete formulation further includes (a) a water reducing agent, (b) a set time retarder or (c) a set time retarder and a water reducing agent.

19. The concrete formulation of claim 18, wherein the aggregate component includes screen fractions of aggregates that are less than 250 microns in diameter consisting of multiple sizes or fractions of limestone (or dolomitic limestone, dolomite, or quartz sand) aggregates ranging up to no more than 200 microns in diameter and fine aggregates that include milled limestone, Class F fly ash, and/or quartz flour wherein a relative proportion of fine aggregate and cement increases proportionately with the targeted decrease in concrete density.
